(19) United States
(12) Patent Application Publication
(10) Pub. No.: US 2014/0043278 A1
(43) Pub. Date: Feb. 13, 2014

(54) ELECTRODE CONFIGURATION FOR LARGE TOUCH SCREEN

(71) Applicant: Thomas J. Rebeschi, Merrimack, NH (US)

(72) Inventor: Thomas J. Rebeschi, Merrimack, NH (US)

(73) Assignee: 3M Innovative Properties Company

(21) Appl. No.: 13/570,924

(22) Filed: Aug. 9, 2012

(51) Int. Cl. G06F 3/044

(52) U.S. Cl. 345/174

(57) ABSTRACT

A matrix-type mutual capacitive touch sensitive panel and associated touch sensing electronics, wherein the touch sensing electronics electrically couple to individual receive electrodes at a plurality of terminal areas on each individual receive electrode.

### BACKGROUND

The present disclosure relates to display device and more particularly to display devices having touch screens.

Mutual capacitive-based touch sensors typically comprise a matrix-type sensor, with an array of driven electrodes orthogonally oriented to an array of receive electrodes, with a dielectric in between. The areas where electrodes of the respective arrays cross over one another may be called nodes. The driven electrodes capacitively couple to the receive electrodes at the nodes, and a finger or other pointing object located proximate to the matrix interferes with said coupling, allowing the finger's location relative to the matrix to be sensed and computed with associated electronics.

Such sensors, when coupled to suitable electronics such as those described in U.S. patent application Ser. No. 12/786,920 “High Speed Multi-Touch Device and Controller Therefor”, may provide extremely fast response times (latency effectively unnoticeable to casual users of the touch screen) and the ability to sense a large number of simultaneous touches (forty or more).

However, such sensors have size limitations, primarily due to signal sensitivity limitations. As the length of row and column signal lines increases to accommodate larger sizes, the impedance of that signal line also increases, which reduces the signal to noise properties of the signal. As a result, mutual capacitive-based touch sensors are generally limited to smaller sensor applications.

Some manufacturers have addressed this size limitation problem by effectively splitting their touch sensors into halves or quadrants, and independently sensing touch events occurring in each respective half or quadrant. For example, U.S. Patent Application Publication No 2010/0156795 describes capacitive touch screen panels assembled in a planar arrangement from two or four sections, with each section including at least two so-called “active” edges intended for coupling to electronics.

Another approach is to use micro-wires or other materials better suited for longer electrode spans.

### SUMMARY

A sensor for use in a mutual-capacitive touch sensitive device includes drive and receive electrodes in a matrix-type configuration. Sensing electronics are coupled to individual receive electrodes by way of a plurality of terminal areas, rather than just one. In a preferred embodiment, the terminal areas are associated with separate ends of a given receive electrode.

Particularly, in one embodiment, a touch-sensitive apparatus is described, the apparatus comprising a touch panel comprising a touch surface and a plurality of electrodes defining an electrode matrix, the plurality of electrodes comprising a plurality of drive electrodes and a plurality of receive electrodes, each receive electrode comprising a first and second terminal area, each drive electrode being capacitively coupled to each receive electrode at a respective node of the matrix, the panel being configured such that a touch on the touch surface proximate a given one of the nodes changes a coupling capacitance between the drive electrode and the receive electrode associated with the given node; and, a controller comprising a plurality of sense components such that there is a sense component associated with each receive electrode, and wherein the sense component associated with at least one of the receive electrodes is communicatively coupled to both the first and second terminal areas of the at least one receive electrode via control lines.

This and other embodiments are described further in the detailed description.

### BRIEF DESCRIPTION OF DRAWINGS

FIG. 1 is a schematic view of a touch device;

FIG. 2 is a schematic side view of a portion of a touch panel used in a touch device; and,

FIG. 3 is a circuit diagram of a sense component coupled to an individual receive electrode.

In the figures, like reference numerals designate like elements.

### DETAILED DESCRIPTION OF ILLUSTRATIVE EMBODIMENTS

This disclosure is directed to a novel means of coupling sensing electronics of a touch sensitive device, such as a matrix capacitive touch screen, to the receive electrodes. In particular, sensing electronics associated with each receive electrode are coupled to two terminal areas (for example, both ends) of a given receive electrode. This configuration reduces the resistance path of any given receive electrode by half. In some embodiments, such an approach may be employed without additional sensing electronics.

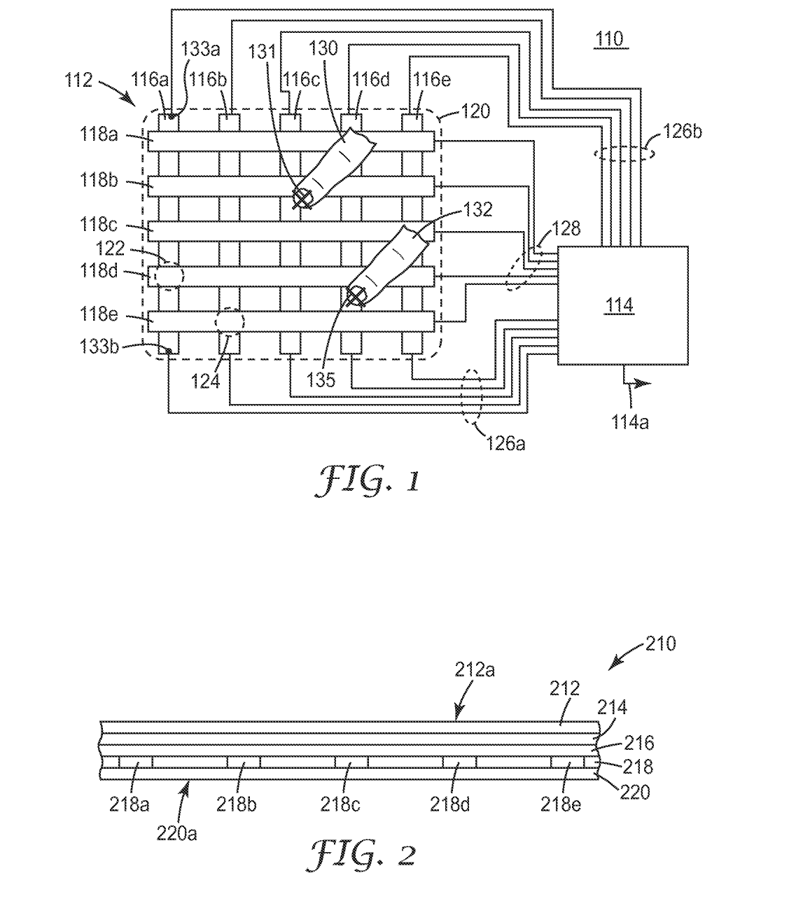

In FIG. 1, an exemplary touch device 110 is shown. The device 110 includes a touch panel 112 connected to electronic circuitry, which for simplicity is grouped together into a single schematic box labeled 114 and referred to collectively as a controller. The touch panel 112 is shown as having a 5×5 matrix comprised of a lower array of column electrodes 116a-e and an upper array of row electrodes 118a-e, but other numbers of electrodes and other matrix sizes can also be used. The panel 112 is typically substantially transparent so that the user is able to view an object, such as the pixilated display of a computer, hand-held device, mobile phone, or other peripheral device, through the panel 112. The boundary 120 represents the viewing area of the panel 112 and also preferably the viewing area of such a display, if used. Electrodes 116a-e, 118a-e are spatially distributed, from a plan view perspective, over the viewing area 120. For ease of illustration the electrodes are shown to be wide and obtrusive, but in practice they may be relatively narrow and inconspicuous to the user. Further, they may be designed to have variable widths, e.g., an increased width in the form of a diamond- or other-shaped pad in the vicinity of the nodes of the matrix in order to increase the inter-electrode fringe field and thereby increase the effect of a touch on the electrode-to-electrode capacitive coupling. In exemplary embodiments the electrodes may be composed of indium tin oxide (ITO), a network of fine micro-conductor wires, or other suitable electrically conductive materials. From a depth perspective, the column electrodes may lie in a different plane than the row electrodes (from the perspective of

FIG. 1, the column electrodes 116a-e lie underneath the row electrodes 118a-e) such that no significant ohmic contact is made between column and row electrodes, and so that the only significant electrical coupling between a given column electrode and a given row electrode is capacitive coupling. In other embodiments, the row electrode and discreet column electrode components may be disposed on the same substrate, in the same layer, then bridging jumper electrodes configured to connect the discreet column electrode components (spaced apart from the column electrode by a dielectric) to thus form x- and y- electrodes using a substantially single layer construction. The matrix of electrodes typically lies beneath a cover glass, plastic film, or the like, so that the electrodes are protected from direct physical contact with a user's finger or other touch- related implement. An exposed surface of such a cover glass, film, or the like may be referred to as a touch surface.

The skilled artisan will recognize a diversity of approaches to configure controller 114 to ultimately sense touches occurring on the touch surface. In one typical arrangement, controller 114 is configured to cause a drive signal to be iteratively injected into driven electrodes 118a-e (i.e., a drive signal generators injects a signal into drive lines, one at a time). After driving a given row, sensing components associated with each receive electrode (electrodes 116a-e) are sampled by electronics included in controller 114, which determines touch-related data for the nodes (in this case five) associated with the cross-over points associated with the driven electrode and the array of receive electrodes. The sense components associated with each receive electrode would typically include analog electronics having an output that changes as a function of the capacitive coupling of the signal injected into the driven electrode with the receive electrode. After being queried by the controller, the sense components may be reset (depending on their configuration), then a signal injected into the next driven electrode, and so forth. A full cycle, driving each driven electrode as such, with associated sensing, yields a matrix of values, where samples associated with lower capacitive coupling at electrode cross-over points correspond with conductive objects, such as one or more fingers, being located proximate, or touching, the touch surface.

The capacitive coupling between a given row and column electrode is primarily a function of the geometry of the electrodes in the region where the electrodes are closest together, i.e., the cross over point of a driven and receive electrode. Such regions correspond to the nodes of the electrode matrix, some of which are labeled in FIG. 1. For example, capacitive coupling between column (receive) electrode 116a and row (driven) electrode 118d occurs primarily at node 122, and capacitive coupling between column (receive) electrode 116b and row (driven) electrode 118e occurs primarily at node 124. The 5×5 matrix of FIG. 1 has 25 such nodes, any one of which can be addressed by controller 114 via appropriate selection of the control lines associated with receive electronics (receive control lines 126a and 126b, respectively), which individually couple the respective receive electrodes 116a-e to the controller, and appropriate selection of one of the control lines 128, which individually couple the respective driven electrodes 118a-e to the controller.

Receive electrodes 116a-e each include first and second terminal areas 133a and 133b, respectively (present, but not shown on receive electrodes 116b-e). Driven electrodes 118a-e are shown coupled to control line 128 via only one such terminal area each, but other configurations where the drive line includes two terminal areas, such as the configuration shown with respect to electrode 116a, are also possible. A control line from the set of control lines 126b couples to the first terminal area of receive electrode 116a at terminal area 133a. A control line from the set of control lines 126a couples to the second terminal area of receive electrode 116a at terminal area 133b. In one embodiment, the control lines coupled to the first and second terminal areas 133a and 133b are coupled together within controller 114, to form a circuit including receive electrode 116a, which is then coupled to a sensing component (such as the sense component described in U.S. patent application Ser. No. 12/786,920 “High Speed Multi-Touch Device and Controller Therefor” which is hereby incorporated by reference in its entirety). Sensing components generally involve analog circuitry configured to produce an output that varies as a function of the capacitive coupling of the drive signal injected into the drive electrode and the respective receive electrode.

The control line associated with terminal area 133a may be coupled to an associated first sensing component in controller 114. The control line associated with terminal area 133b may be coupled to an associated second sensing component in controller 114. This approach, of having each terminal end of each receive electrode coupled to independent sense components, may allow a stronger signal to couple to the sense components, but would have the downside of doubling the number of sensing components needed for a touch panel, that is, a ratio of receive electrodes to sensing components of 1:2. Another approach is to have the control line associated with terminal area 133b couple to the same sensing component as the control line associated with terminal area 133a (that would be, in the case of the example above, the first sensing component), that is, a ratio of receive electrodes to sensing components of 1:1. In such a configuration, further described with respect to FIG. 3, the receive electrode acts much like a receive electrode having half of its width, which allows a touch panel to double the dimension that is associated with the receive electrode. For example, on a touch panel having a 16×9 aspect ratio, the horizontal electrodes may be the size limiting factor. Connecting at terminal areas associated with both ends of the receive electrode may allow the length of the electrode to double (other factors, such as electrode geometry and electrical properties, being equal). This is partly because signal degradation issues are reduced, particularly to the electrode that would have been farthest from a control line in a traditional single-connection point scheme. Problems of stray capacitance associated with coupling sensing electronics to only one terminal end of a touch screen electrode are also reduced. Coupling sensing components to two terminal areas of the electrode may also reduce the effective resistivity of the given receive electrode by about half. The RC time constant associated each receive electrode is also halved, which may allow the circuit to be faster. For example, a receive electrode time constant for a 30 inch electrode may be a limiting factor when that electrode is coupled to sensing electronics on one end only; but when both sides are connected in parallel the resistance is cut in half and thus a sensor with 60 inch electrodes could be driven with the same electronics timing.

When a finger 130 of a user or other touch implement comes into contact or near-contact with the touch surface of the device 110, as shown at touch location 131, the finger capacitively couples to the electrode matrix. The finger capacitively couples to the matrix, and draws charge away from the matrix, particularly from those electrodes lying closest to the touch location, and in doing so it changes the coupling capacitance between the electrodes corresponding to the nearest node(s). For example, the touch at touch location 131 lies nearest the node corresponding to electrodes 116c/118b. This change in coupling capacitance can be detected by controller 114 and interpreted as a touch at or near the 116a/118b node. Preferably, the controller is configured to rapidly detect the change in capacitance, if any, of all of the nodes of the matrix, and is capable of analyzing the magnitudes of capacitance changes for neighboring nodes so as to accurately determine a touch location lying between nodes by interpolation. Furthermore, the controller 114 advantageously is designed to detect multiple distinct touches applied to different portions of the touch device at the same time, or at overlapping times. Thus, for example, if another finger 132 touches the touch surface of the device 110 at touch location 135 simultaneously with the touch of finger 130, or if the respective touches at least temporally overlap, the controller is preferably capable of detecting the positions 131, 133 of both such touches and providing such locations on a touch output 114a.

Additionally, in display-type applications, a back shield may be placed between the display and the touch panel 112. Such a back shield typically consists of a conductive ITO coating on a glass or film, and can be grounded or driven with a waveform that reduces signal coupling into touch panel 112 from external electrical interference sources. Other approaches to back shielding are known in the art. In general, a back shield reduces noise sensed by touch panel 112, which in some embodiments may provide improved touch sensitivity (e.g., ability to sense a lighter touch) and faster response time. Back shields are sometimes used in conjunction with other noise reduction approaches, including spacing apart touch panel 112 and a display, as noise strength from LCD displays, for example, rapidly decreases over distance. In addition to these techniques, other approaches to dealing with noise problems are discussed in reference to various embodiments, below.

The controller 114 preferably employs a variety of additional circuit modules and components, such as application specific integrated circuits (ASICs) that enable it to rapidly determine the coupling capacitance at some or all of the nodes of the electrode matrix, and therefrom determine the occurrence of contacts made to the surface of the touch panel, and provide output indicative of the locations of the contact to another system, such as a computer system, which in turn may update a graphical user interface of a display that is associated with touch panel 112.

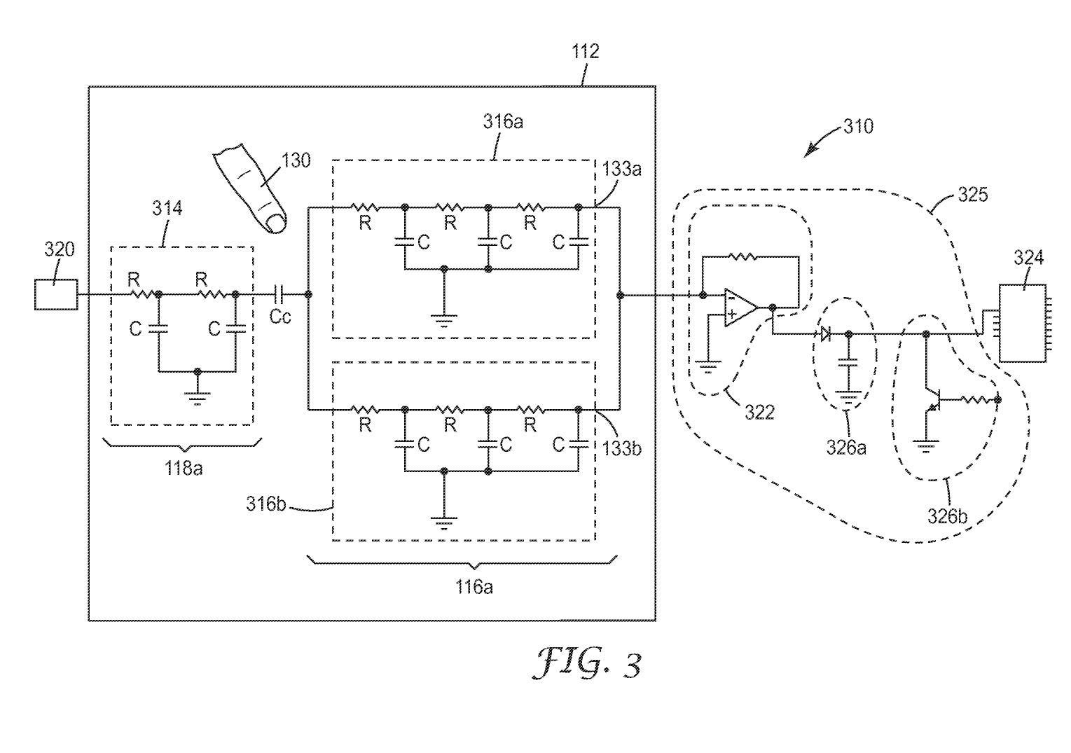

Turning now to FIG. 2, we see there a schematic side view of a portion of a touch panel 210 for use in a touch device. The panel 210 includes a front layer 212, first electrode layer 214 comprising a first set of electrodes, insulating layer 216, second electrode layer 218 comprising a second set of electrodes 218a-e preferably orthogonal to the first set of electrodes, and a rear layer 220. The exposed surface 212a of layer 212, or the exposed surface 220a of layer 220, may be or comprise the touch surface of the touch panel 210.

Turning now to FIG. 3, we see a schematic view of device 310, which includes a representation of a drive and receive electrode pair (drive electrode 118a; receive electrode 116a) with a capacitive coupling Cc between them. Sense component 325 is electrically coupled to two terminal areas (133b and 116a) of receive electrode 116a. Control lines associated with the two terminal areas converge at common circuit point 321. Electrode end 316a and 316b represent the ends of receive electrode 116a. The representation of the drive and receive electrode represents, for example, the node that exists between the cross-over area of electrode 116a and 118a in FIG. 1. Device 310 shows one embodiment of a drive/receive electrode pair in combination with a particular sense component scheme, based on that described in U.S. patent application Ser. No. 12/786,920, earlier incorporated by reference. In that application, constituent components of what is herein referred to generally as the sense component 325 includes a sense unit 322, a peak detection circuit 326a, and a reset circuit 326b; it produces an output that varies as a function of the capacitive coupling of drive and receive electrode, Cc. The example shown in FIG. 3 of the sense component is for illustrative purposes only and should not be viewed as limiting; the skilled artisan will recognized myriad other approaches to designing the sense component. Device 310 additionally includes a drive signal generator 320, to inject a signal into a drive electrode, and ADC 324, to sample an output of the sense component designed to vary as a function of Cc. Not shown in FIG. 3 are further electronics and ASICs electrically coupled to drive signal generator 320 and ADC 324. Sense component 325 and ADC 324 could exist as part of controller 114, or could also be on a separate substrate.

Unless otherwise indicated, all numbers expressing quantities, measurement of properties, and so forth used in the specification and claims are to be understood as being modified by the term “about”. Accordingly, unless indicated to the contrary, the numerical parameters set forth in the specification and claims are approximations that can vary depending on the desired properties sought to be obtained by those skilled in the art utilizing the teachings of the present application. Not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, to the extent any numerical values are set forth in specific examples described herein, they are reported as precisely as reasonably possible. Any numerical value, however, may well contain errors associated with testing or measurement limitations.

Various modifications and alterations of this invention will be apparent to those skilled in the art without departing from the spirit and scope of this invention, and it should be understood that this invention is not limited to the illustrative embodiments set forth herein. For example, the reader should assume that features of one disclosed embodiment can also be applied to all other disclosed embodiments unless otherwise indicated. It should also be understood that all U.S. patents, patent application publications, and other patent and non-patent documents referred to herein are incorporated by reference, to the extent they do not contradict the foregoing disclosure.

1. A touch-sensitive apparatus, comprising:
a touch panel comprising a touch surface and a plurality of electrodes defining an electrode matrix, the plurality of electrodes comprising a plurality of drive electrodes and a plurality of receive electrodes, each receive electrode comprising a first and second terminal area, each drive electrode being capacitively coupled to each receive electrode at a respective node of the matrix, the panel being configured such that a touch on the touch surface proximate a given one of the nodes changes a coupling capacitance between the drive electrode and the receive electrode associated with the given node; and,
a controller comprising a plurality of sense components such that there is a sense component associated with each receive electrode, and wherein the sense component associated with at least one of the receive electrodes is communicatively coupled to both the first and second terminal areas of the at least one receive electrode via control lines.

2. The touch-sensitive apparatus of claim 1, wherein the controller further comprises:
electronics communicatively coupled to the sense components to sample the sense components and determine therefrom coordinates of one or more touches occurring on the touch surface.

3. The touch sensitive apparatus of claim 2, wherein the sense component comprises analog electronic circuitry with an output that varies as a function of the capacitive coupling of a signal between a respective drive electrode and receive electrode at a node.

4. The touch sensitive apparatus of claim 3, wherein each receive electrode has a first end and a second end, and the first and second terminal areas are positioned proximate the first and second ends, respectively.

5. The touch sensitive apparatus of claim 4, the controller further comprising a drive signal generator to inject a drive signal into individual drive electrodes one at a time.

6. The touch sensitive apparatus of claim 5, wherein each drive electrode comprises a first and second terminal area, and wherein a drive signal generator is electrically coupled to both the first and second terminal area of each drive electrode, and wherein the drive signal generator injects a drive signal into each drive electrode.
